(19) United States
(12) Patent Application Publication
(10) Pub. No.: US 2006/0246243 A1
(43) Pub. Date: Nov. 2, 2006

(54) Resin and ink for the printing of shrink sleeves

(75) Inventors: Denis Eugène, La Roche sur Foron (FR); Gilles Eiselé, Fillinges (FR); Gilles Catherin, Genis Pouilly (FR)

Correspondence Address: SHOEMAKER AND MATTARE, LTD, 10 POST OFFICE ROAD - SUITE 110, SILVER SPRING, MD, 20910, US

(73) Assignee: SIPCA Holding S.A., Prilly (CH)

(21) Appl. No.: 10/560,607

(22) PCT Filed: Jun. 29, 2004
(86) PCT No.: PCT/EP04/07029

§ 371 Date: Mar. 27, 2006

(30) Foreign Application Priority Data
Jul. 4, 2003 (EP) 03015170.8

(51) Int. Cl. F16B 4/00; C08G 18/00

(52) U.S. Cl. 428/34.9; 528/44

(57) ABSTRACT

The present invention relates to a Polyurethane resin, obtainable by reacting an excess of one or more aliphatic diisocyanates with a group of isocyanate-reactive components consisting of one or more polyether polyols each having an average molecular weight in the range of 1000 to less than 3000 g/mol alone or in admixture with one or more polyester polyols each having an average molecular weight in the range of 1000 to less than 3000 g/mol; adding at least one diamine; adding of one or more polyols each having an average molecular weight of equal or less than 800 g/mol either before or after the reaction with the at least one diamine; and optionally reacting the product obtained in steps a) to c) with at least one terminating agent. The present invention is also related to binder materials and shrink sleeve printing inks comprising the above polyurethane resins.

The present invention relates to specific polyurethane resins useful as binders in inks for printing shrink sleeves, to the ink comprising said binders and to methods of preparing and using said binders and inks.

Shrink sleeves or shrink labels have become a very popular means for providing images and information, for example to prevent tampering, to products such as bottles, cans and jars. A shrink sleeve or shrink label is a film of an oriented plastic sheet or tube. Said film may be printed, formed into a tube and wound onto a core. A desired part of said wound film is unwound, cut and placed on or around the item to which said sleeve or label is to be applied. By applying heat to the film, the film is caused to shrink and to conform exactly to the shape of the item.

The advantage of shrink sleeves is that it is much easier to print designs, complicated images etc. onto said sleeves before they are applied to an item as compared to directly printing said designs, information, images etc. to the items. A further advantage is that shrink sleeves may provide protection against UV light.

The shrink sleeves are printed by means of either an flexographic or rotogravure process. The print may be provided onto the surface or the reverse side of the film forming the shrink sleeve. It is preferred to provide the print on the reverse side of the film since it is then protected against environmental influences.

In order to be useful for the printing of shrink sleeves, besides the common requirements imposed by the flexographic or rotogravure process, an ink system must have excellent adhesion and flexibility, before and after the shrinking of the film. In particular, it must exhibit good tape adhesion, wrinkle adhesion, and scratch resistance before and after the shrinking process, respectively. The ink should exhibit no blocking of ink to ink as well as of ink to the reverse side of the film. Furthermore, for certain applications, for example in the food industry, the ink system should be capable of withstanding the conditions of a pasteurisation. Moreover, the ink should exhibit low levels of retained solvent after printing and have a low odour level.

The printing inks currently used for printing shrink sleeves are based on an acrylic resin and cellulose acetate propionate (CAP). While nitrocellulose is the most common resin employed in solvent-based flexographic inks, up to now no suitable binder resin is known which in combination with nitrocellulose provides the required characteristics for a shrink sleeve printing ink. It would be desirable to use nitrocellulose instead of CAP, since CAP has a more limited compatibility, for example with respect to various pigments. Also, adhesion of the currently used CAP/acrylic inks on several films such as oriented polystyrene (OPS) is not satisfactory.

Inks on the basis of nitrocellulose and specific polyurethane resins are known in the art. Such flexographic inks are described, for example, in EP-A-0 730 014, WO 02/38643, GB-2 161 817, or U.S. Pat. No. 4,111,916. However, the use of such inks for printing shrink sleeves has not been suggested yet.

It was therefore the object of the present invention to provide a binder resin which can be used in combination with nitrocellulose for the manufacture of a shrink sleeve printing ink, and to provide such a shrink sleeve printing ink comprising nitrocellulose.

It has been surprisingly found that printing inks excellently fulfilling the requirements for shrink sleeve printing can be made using a polyurethane resin according to claim 1. In particular, said polyurethane resin is obtainable by
a) reacting an excess of one or more aliphatic diisocyanates with a group of isocyanate-reactive components consisting of one or more polyether polyols each having an average molecular weight in the range of 1000 to less than 3000 g/mol alone or in admixture with one or more polyester polyols each having an average molecular weight in the range of 1000 to less than 3000 g/mol;
b) adding at least one diamine;
c) adding one or more polyols each having an average molecular weight of equal or less than 800 g/mol either before or after the reaction with the at least one diamine; and
d) optionally reacting the product obtained in steps a) to c) with at least one terminating agent.

According to the present invention, all molecular weights are weight average molecular weights.

The term “aliphatic diisocyanate” is to be understood as to comprise straight-chain aliphatic, branched aliphatic as well as cycloaliphatic diisocyanates. Preferably, the diisocyanate comprises 1 to 10 carbon atoms. Examples of preferred diisocyanates are 1,4-diisocyanatobutane, 1,6-diisocyanatohexane, 1,5-diisocyanato-2,2-dimethylpentane, 4-trimethyl-1,6-diisocyanatohexane, 1,10-diisocyanatodecane, 1,3- and 1,4-diisocyanatocyclo-hexane, 1-isocyanato-5-isocyanatomethyl-3,3,5-trimethylcyclohexane (isophorone diisocyanate (IPDI)), 2,3-2,4- and 2,6-diisocyanato-1-methylcyclohexane, 4,4′- and 2,4′-diisocyanatodicyclohexylmethane, 1-isocyanato-3-(4)-isocyanatomethyl-1-methyl-cyclohexane, 4,4′- and 2,4′-diisocyanatodiphenylmethane, and mixtures thereof, or 2,2,4- or 2,4,4-trimethyldiisocyanatohexane (TMDI).

The polyetherpolyol components of the polyurethane resin of present invention are generally defined by the formula 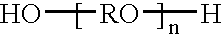
wherein R is a C₂ to C₁₀ straight chain or branched hydrocarbon group. Preferably, R is an alkylene group comprising 2 to 4 carbon atoms. Examples of preferred polyether polyols include polyethyleneether glycols (PEG), polypropyleneether glycols (PPG) and polytetramethylene ether glycols (Poly-THF), or a mixture thereof. According to the present invention, the use of Poly-THF is particularly preferred. In the above formula, n is chosen such that the average molecular weight of the polyether polyols ranges from 1000 to less than 3000, preferably from 1000 to 2000. An especially preferred polyetherpolyol of the present invention is Poly-THF 2000.

The one or more diisocyanates and the one or more polyether polyols are reacted with each other to form a first isocyanate-terminated prepolymer. Therefore, an excess of one or more diisocyanates is reacted with the one or more poyletherpolyols. According to the present invention, the ratio of equivalent weights of diisocyanate components to polyetherpolyol components is in a range of 3.6:1 and 1:1, preferably 2:1.

The reaction is carried out under conditions which are well known to those skilled in the art. According to a preferred embodiment, the reaction is carried out in the presence of a solvent using well-known catalysts.

Examples of suitable solvents are alkyl acetates such as methyl acetate, ethyl acetate, propyl acetate, butyl acetate and pentyl acetate. The total amount of solvent typically ranges from 0 to 90 percent by weight of the reaction mixture, preferably from 25 to 60 percent by weight of the reaction mixture.

A catalyst may be advantageously employed to accelerate the reaction of diisocyanate with diol. Suitable catalysts are tin derivatives such as stannous octylate, stannous oxalate, dibutyltin dilaurate, zinc derivatives such as zinc diacetate, zinc bisacetyl acetonate or Organotitanium compounds such as tetrabutytitanate, or mixtures thereof.

Further additives may be present. For example, an antioxidant such as Irganox 1076 (octadecyl-3,5-di-t-butyl-4-hydroxyhydrocinnamate) may be added.

Formation of the isocyanate-terminated prepolymer is generally carried out at a temperature ranging from 0 to 130° C., preferably ranging from 50 to 90° C. The time of the reaction generally ranges from a period of from 1 to 12 hours, preferably from 1 to 4 hours.

The thus formed isocyanate-terminated prepolymer is chain-extended with at least one diamine. The diamine can be any aliphatic, cycloaliphatic, aromatic, or heterocyclic diamine having primary or secondary amino groups. According to the present invention, hydrazine is not comprised by the group of diamines. Example are ethylenediamine, 1,2-diaminopropane, 1,3-diaminopropane, diaminobutane, hexamethylenediamine, 1,4-diaminocyclohexane, 3-aminomethyl-3,5,5-trimethylcyclohexylamine (isophorone diamine), m-xylylene diamine or 1,3-bis (aminomethyl) cyclohexane. According to the present invention, isophorone diamine is particularly preferred.

According to the present invention, it is preferred that only a small chain-extension with the diamine is carried out. Therefore, the ratio of equivalent weights of the isocyanate-terminated prepolymer to the diamine components is in a range of 10:1 and 5:1, preferably 7:1 and 5:1. Thus, the product of this reaction is a chain-extended isocyanate-terminated prepolymer.

The reaction is carried out under conditions which are well known to those skilled in the art. According to a preferred embodiment, the reaction is carried out by adding the diamine dissolved in one of the solvents mentioned before as solvents for the reaction of the diisocyanate with the polyetherpolyol to the reaction mixture. The reaction is generally carried out at a temperature ranging from 0 to 90° C., preferably from 25 to 75° C., for 5 minutes to 2 hours.

The chain-extended isocyanate-terminated prepolymer is reacted with one or more polyols each having an average molecular weight of equal or less than 800 g/mol. According to the present invention, the term polyol is to be understood to comprise chemical substances having at least two hydroxyl groups. In this step, a significant chain extension of the prepolymer is carried out. According to the present invention, diols such as 1,4-butanediol, 1,6-hexanediol, neopentyl glycol, dihydroxy polyetherpolyols, polyesterpolyols or the like are preferred as polyol component. The ratio of equivalent weights of the chain-extended isocyanate-terminated prepolymer to the polyol components of this section is in a range of 2:1 and 1:1, preferably 1.6:1 and 1.2:1.

The reaction is carried out under conditions which are well known to those skilled in the art. According to a preferred embodiment, the reaction is carried out by adding the one or more polyols to the reaction mixture. The reaction is generally carried out at a temperature ranging from 0 to 90° C., preferably from 25 to 75° C., for 30 minutes to 3 hours.

According to the present invention, however, the steps of reacting the isocyanate-terminated prepolymer with at least one diamine and with at least one polyol having an average molecular weight of less than 800 g/mol can be also carried out the other way round, i.e. first reacting the isocyanate-terminated prepolymer with at least one polyol having an average molecular weight of less than 800 g/mol, and thereafter with at least one diamine. Which route is preferred depends on the components used, and can be easily retrieved by a man skilled in the art

The thus formed prepolymer may further be reacted with one or more terminating agents. The terminating agents can be chosen from the group consisting of amines and alcohols. Examples of amines are monamines and diamines are butylamine, dibutylamine, amino-propylmorpholine, aminoethylpiperazine, dimethylaminopropylamine, di(isopropanol) amine, aminoethoxyethanol, ethanolamine, dimethanolamine, 4-aminophenol, isophoronediamine, or oleyl amine. Examples of alcohols are 1-propanol, 2-propanol, 1-butanol, 2-butanol, neopentyl alcohol, ethanol, or oleyl alcohol. The ratio of equivalent weights of the prepolymer to the terminating agents is in a range of 10:1 and 2:1.

The reaction is carried out under conditions which are well known to those skilled in the art. According to a preferred embodiment, the reaction is carried out by adding the one or more terminating agents to the reaction mixture. The reaction is generally carried out at a temperature ranging from 0 to 90° C., preferably from 25 to 75° C., for 50 minutes to 1 hour.

Optionally, the final product can be diluted in a solvent such as an alcohol, preferably ethanol, or an ester such as n-propyl acetate, in order to obtain a clear solution.

The thus prepared polyurethane resin has a weight average molecular weight in the range of 20000 to 80000 g/mol, preferably between 25000 to 55000 g/mol. The resin is soluble in organic solvents comprising alcohols such as ethanol. The resin according to the present invention preferably has a degree of urethanisation between 10 and 30%.

Although the above described polyurethane resin is most preferred according to the present invention, it has been found out that also other polyurethane resins can be successfully used. For example, polyurethane resins can be used wherein besides the above-mentioned components also at least one polyester component having an average molecular weight of from 1000 to less than 3000 g/mol is added during the first step of the preparation of the polyurethane resin. An example for such a polyester component is Fomrez 3089, a commercially available polyester polyol from Crompton, having an average molecular weight of about 2000 g/mol. Fomrez is a tradename for glycol adipate polyester polyols. The glycol moiety can be ethylene glycol, dipropylene glycol, diethylene glycol, neopentyl glycol, hexanediol, or butanediol. However, also other polyester polyols such as the ones obtained by condensation of at least one dibasic acid or anhydrides thereof, such as adipic acid, phthalic acid, isophtalic acid, maleic acid, fumaric acid, or succinic acid, with at least one glycol such as linear or branched alkylene diols, e.g. butanediol, propylene glycol, hexane diol, or neopentyl glycol. In this case, the ratio of equivalent weights of diisocyanate components to the isocyanate-reactive components, which are composed of the polyetherpolyol and polyesterpolyol components, is in a range of 3.6:1 and 1:1, preferably 2:1. The other reaction conditions are the same as mentioned above when only polyetherpolyols are used.

The resulting polyurethane resin or its clear solution in the above mentioned solvent, for example ethanol or n-propyl acetate, can be used directly, without other additives, as a binder material for shrink sleeve inks. Depending on the specific requirements, however, additives such as, e.g., fillers, thickeners, other co-resins, waxes such as armid wax, etc may be added. According to a preferred embodiment of the present invention, the binder for the shrink sleeve ink comprises 40 to 70 wt.-% of the polyurethane resin, 5 to 20 wt.-% of one or more waxes, and the balance of solvent.

It has been surprisingly found that by using the above described specific polyurethane resin as binder material, printing inks on the basis of nitrocellulose can be manufactured which fulfil all the requirements imposed to a shrink sleeve printing ink. The use of nitrocellulose provides a higher compatibility of the printing ink with respective to pigments as compared to inks on the basis of CAP.

For preparing a shrink sleeve printing ink according to the present invention, the binder material defined above is combined with a pigment to form a printing ink composition. Optionally, a solvent and other additives such as fillers, surfactants, varnishes, wax and the like may be added depending upon the specific requirements imposed on the printing ink.

The generic term pigment is specifically used in this specification in that it is intended to refer to both pigments and dyes which impart a distinct color to the printing ink composition. Due to the use of nitrocellulose instead of CAP, according to the present invention any pigment which is typically used in flexographic or rotogravure inks such as monoazo yellows (e.g. C1 Pigment Yellows 3, 5, 98); diarylide yellows (e.g. C1 Pigment Yellows 12, 13, 14); Pyrazolone Orange, Permanent Red 2G, Lithol Rubine 4B, Rubine 2B, Red Lake C, Lithol Red, Permanent Red R, Phthalocyanine Green, Phthalocyanine Blue, Permanent Violet, titanium dioxide, carbon black, etc, may be used.

The pigment is employed in amounts of from 10 to 60 percent by weight, based on the weight of the ink composition.

The pigment is combined with the binder material by any convenient method. According to the present invention, the pigment is provided in form of a dispersion in nitrocellulose. Dispersion of the pigment in nitrocellulose can be carried out, for example, by milling methods. Examples are ball mill, sand mill, horizontal media mill, high-shear fluid flow mill, or the like.

The printing inks according to the present invention comprise 20 to 50 wt.-% of the above described polyurethane resin as a binder material.

Additionally, the printing inks according to the present invention may comprise a solvent and other additives such as fillers, surfactants, varnishes, wax and the like. According to a preferred embodiment of the present invention, the printing ink comprises 1 to 10 wt.-% of one or more additives. A preferred additive for use in the printing inks according to the present invention is a ketonic varnish formed by condensation of cyclohexanone and formaldehyde.

As additional solvent components forming the balance of the printing ink, alcohols such as ethanol, n-propanol or methoxypropanol, or esters such as ethyl acetate or n-propyl acetate may be used.

The printing ink according to the present invention excellently fulfils all the requirements imposed to a shrink sleeve printing ink, i.e. an ink useful for printing shrink sleeves. In particular, the printing ink according to the present invention
can be printed by means of a flexographic and of a rotogravure process resulting in excellent print quality
exhibits excellent adhesion and flexibility; in particular, the ink exhibits excellent adhesion before and after the shrinking of the film
exhibits excellent tape adhesion
exhibits excellent wrinkle adhesion
exhibits excellent scratch resistance before and after the shrinking process
exhibits no blocking of ink to ink as well as of ink to the reverse side of the film
is capable of withstanding the conditions of a pasteurisation
exhibits low levels of retained solvent after printing
has a low odour level.

According to the present invention, the term shrink sleeve is to be understood to comprise shrink sleeve labels as well as roll-fed, wrap-around shrink labels in both unshrinked tubular form as well as in the final shrinked form.

The printing ink according to the present invention shows a superior adhesion to the film-forming materials of shrink sleeves as compared to the conventional shrink sleeve printing inks on the basis of cellulose acetate propionate (CAP) and acrylic resin.

The films from which the shrink sleeves are formed are usually made of polyvinylchloride (OVC), polyesters such as polyethylene terephthalate (PET), glycol-modified polyesters such as polyethylene terephthalate glycol (PETG), oriented polystyrene (OPS), polypropylene, or modified polystyrene resins, such as the K resin from Chevron. The importance of OPS as film-forming material is growing, especially because of environmental concerns against the use of PVC. The shrink sleeve printing ink according to the present invention shows a particularly excellent adhesion on OPS.

For the first time, the present invention provides useful shrink sleeve printing inks on the basis of nitrocellulose. This is made possible by the use of a polyurethane binder resin, in particular of a polyurethane binder resin as described above.

The present invention also provides shrink sleeves comprising the above described shrink sleeve printing ink on at least part of its surface portion.

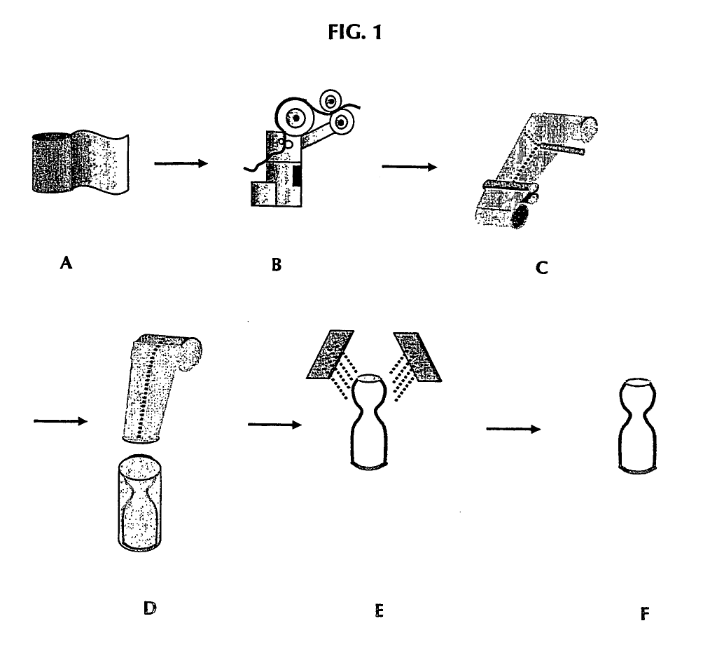

Hereinafter, the process of manufacturing shrink sleeves is generally outlined by reference to FIG. 1, which is not intended to limit the scope of the present application.

In a first step (A), the film material for forming the shrink sleeves is provided. Generally, shrink sleeves are made from films having a thickness of about 30 to 70 μm. A preferred thickness is 40 to 50 μm. Typically, films for shrink sleeves have a transverse direction orientation (TD) of 50-52% or of 60-62%. The films should have a machine direction orientation (MD) of 6-10%, preferably as low as possibly. As film material, any of the above mentioned materials such as OPS, PVC, or PET may be used. According to the present invention, OPS is preferred as material for forming shrink sleeves.

The film material is chosen depending upon the item to which the shrink sleeve is to be applied. In particular, the film material is chosen in view of the shrink ratio required for a specific application. Generally, the amount of shrink in the film should be at least 10% greater than the size of the item around which the shrink sleeve is to be placed, in the area where the greatest amount of shrink is required. OPS is preferred because of its favourable shrinking characteristics.

In a next step (B), the film material is printed with the shrink sleeve printing ink according to the present invention. Said printing can be performed by either the flexographic or the rotogravure process. According to the present invention, the flexographic process is performed.

Both the flexographic and the rotogravure process are known to the man skilled in the art. For details of said processes, reference is made, for example, to R. H. Leach, The printing ink manual, 5^{th} ed., Blueprint, London 1993, the respective portions of which are incorporated herein by reference.

It is preferred that the film material is reverse-printed. This means that the print is on the inside of the finished shrink sleeve. A reverse-printed design etc. is protected against influences from the outside, such as, for example, environmental influences or scratching by a person using the item carrying said shrink sleeve.

In order to provide good surface adhesion of the printing ink, the film material may be surface-treated immediately prior to the printing process. Such surface-treatment processes are known to the man skilled in the art. For example, the film material may be corona-treated.

Thereafter, in a step (C), the printed film is formed into a tube and wound onto a core. Hereby, the log edges of the film are seamed together. The seaming process can be carried out by any method conventionally used for that purpose in the art. For example, seaming may be carried out using a nozzle applying heat to the film portions to be seamed together. Usually, seam areas of 6 to 10 mm are provided.

However, also seamless tubing may be used for making shrink sleeves. In this process, a tube is made by extrusion and applied to the item as described above.

The dimensions of the tube to be formed have to set in view of the item to which the finished shrink sleeve is to be applied. The film material must have a layflat (LF) of one half of the greatest circumference of the item around which the shrink sleeve is to be placed. LF is defined as the distance across the finished tube, not taking into account the material needed for the seam. The actual dimension of the film should, however, exceed the LF in order to allow sliding of the tube over the item to which the finished shrink sleeve is to be applied. Generally, at least 4 mm of distance exceeding the LF are provided to allow sliding.

In a next step (D), the tube is unwound from the core and put over the item to which the shrink sleeve is to be applied. The tube is cut to the appropriate length by means of a cutting device known to the man skilled in the art. Alternatively, the cutting of the tube may be performed prior to putting the tube over the item.

In a next step (E), the tube is shrunk so that the finished shrink sleeve exactly conforms to the shape of the item over which it has been placed. Shrinking of the tube may be carried out by any process commonly used for that purpose in the art. Generally, shrinking is performed by applying heat from suitable heating means such as an oven.

The finished product is an item carrying a shrink sleeve printed with the shrink sleeve printing ink according to the present invention, wherein said shrink sleeve conforms to the shape of said item.

### EXAMPLES

The present invention is hereinafter further illustrated with the aid of non-limiting examples. Unless otherwise indicated, all percentages are weight percents.

### Example 1

### Synthesis of the Polyurethane Resin

A five-neck flask equipped with two additions funnels, a gas introduction means, an agitator and a thermometer is charged with a mixture of 1021 g (52.4 wt.-%) ethyl acetate and 2.0 g (0.1 wt.-%) Irganox 1076. The mixture is thermostated at 25° C. at an agitation velocity of 60 rpm and an nitrogen stream of 0.4 m³/h. The temperature is increased to 60° C. and a mixture of 168 g (1.461 eq) of IPDI and 1.0 g (0.05 wt.-%) zinc bisacetyl acetonate (catalyst) is added to the flask. The agitation velocity is increased to 90 rpm. To the isocyanate solution 38 g (0.076 eq) Poly-THF 1000, 310 g (0.310 eq.) PPG2000, and 17.6 g (0.392 eq.) 1,4-butanediol are added over a period of 10 minutes. The reaction is conducted by a temperature of 74° C. for 120 minutes. In the second step, 302.0 g (52.550 wt.-%, 0.682 eq.) Fomrez 3089 is added over a period of 10 minutes. The reaction is conducted by a temperature of 74° C. for 60 minutes. Thereafter, a mixture of 27.4 g (0.322 eq) isophorone diamine (IPDA) and 27.4 g ethyl acetate is slowly added to the prepolymer solution of the second step. After a reaction time of 30 minutes, 86.0 g of ethanol are added to obtain a polyurethane solution.

The resulting polyurethane had the following characteristics:

Dry content: 41%

Viscosity: 400 mPa's at 25° C.

Degree of Urethanisation: 21.4%

Nitrogen content: 22.5%

Mw: 30000

### Example 2

### Preparation of Shrink Sleeve Printing Ink

A binder material was prepared by mixing 59 wt.-% (dry weight) of the polyurethane resin of example 1, 13.5 wt.-% of wax additives, and 27.5 wt.-% of ethyl acetate. Said binder material was combined with 50 wt.-% of a dispersion of a white pigment (TiO₂) in nitrocellulose prepared by grinding the pigment in the presence of nitrocellulose, 4.0 wt.-% of a ketonic varnish (a solution of the ketonic resin K-1728 from Kraemer (condensation product of cyclohexanone with formaldehyde) in ester and dehydrated alcohol), 9.0 wt.-% of methoxypropanol, 2.0 wt.-% of N-propyl acetate, and 3.0 wt.-% ethanol. The ingredients were mixed by conventional methods known to the man skilled in the art.

1-24. (canceled)

25. Polyurethane resin, obtainable by
a) reacting an excess of one or more aliphatic diisocyanates with a group of isocyanate-reactive components consisting of one or more polyether polyols each having an average molecular weight in the range of 1000 to less than 3000 g/mol alone or in admixture with one or more polyester polyols each having an average molecular weight in the range of 1000 to less than 3000 g/mol;
b) adding at least one diamine;
c) adding one or more polyols each having an average molecular weight of equal or less than 800 g/mol either before or after the reaction with the at least one diamine; and
d) optionally reacting the product obtained in steps a) to c) with at least one terminating agent.

26. Polyurethane resin according to claim 25, wherein the at least one polyetherpolyol has the formula 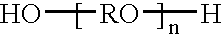
wherein R is a C2 to C10 straight chain or branched hydrocarbon group.

27. Polyurethane resin according to claim 25, wherein the one or more polyester polyols are selected from the group consisting of glycol adipate polyester polyols, or the condensation products of at least one dibasic acid or anhydrides thereof with at least one glycol such as linear or branched alkylene diols.

28. Polyurethane resin according to claim 25, wherein the ratio of equivalent weights of diisocyanate components to the isocyanate-reactive components is in a range of 3.6:1 and 1:1.

29. Polyurethane resin according to claim 25, wherein the least one diamine is an aliphatic, cycloaliphatic, aromatic, or heterocyclic diamine having primary or secondary amino groups.

30. Polyurethane resin according to claim 25, wherein the ratio of equivalent weights of the prepolymer to the diamine components in step b) is in a range of 10:1 and 5:1.

31. Polyurethane resin according to claim 25, wherein the ratio of equivalent weights of the prepolymer to the polyol components in step c) is in a range of 2:1 and 1:1.

32. Polyurethane resin according to claim 25, wherein the ratio of equivalent weights of the prepolymer to the terminating agents in step d) is in a range of 10:1 and 2:1.

33. Polyurethane resin according to claim 25, having weight average molecular weight in the range of 20000 to 80000 g/mol, and a degree of urethanization between 10 and 30%.

34. Process of preparing a polyurethane resin, comprising the steps of
a) reacting an excess of one or more aliphatic diisocyanates with a group of isocyanate-reactive components consisting of one or more polyether polyols each having an average molecular weight in the range of 1000 to less than 3000 g/mol alone or in admixture with one or more polyester polyols each having an average molecular weight in the range of 1000 to less than 3000 g/mol;
b) adding at least one diamine;
c) adding one or more polyols each having an average molecular weight of equal or less than 800 g/mol either before or after the reaction with the at least one diamine; and
d) optionally reacting the product obtained in steps a) to c) with at least one terminating agent.

35. Process according to claim 34, wherein step a) is carried out in the presence of a solvent, a catalyst and optionally additives.

36. Binder material for shrink sleeve printing ink, comprising a polyurethane resin according to claim 25.

37. Binder material according to claim 36, additionally comprising additives and solvent.

38. Process of preparing a binder material for shrink sleeve printing ink, comprising the steps of dissolving a polyurethane resin according to claim 25 in a solvent to provide a clear solution, and optionally adding additives to said clear solution.

39. Shrink sleeve printing ink, comprising a binder material according to claim 36.

40. Shrink sleeve printing ink according to claim 39, additionally comprising a pigment, and nitrocellulose.

41. Process of preparing a shrink sleeve printing ink according to claim 40, comprising the steps of providing a dispersion of said pigment in nitrocellulose, and combining said dispersion with said binder material.

42. Shrink sleeve, comprising a shrink sleeve printing ink according to claim 39 on at least part of its surface portion.

43. Shrink sleeve according to claim 42, wherein the shrink sleeve is made of material selected from the group consisting of oriented polystyrene, polyinvylchloride, polyesters, glycol-modified polyesters, polypropylene, or modified polystyrene resins.

44. Process of manufacturing a shrink sleeve according to claim 42, comprising the steps of
(A) providing a film material;
(B) printing said film material with s shrink sleeve printing ink according to claim 15; and
(C) converting said printed film material into a tube.

45. Process according to claim 44, further comprising the steps of
(D) putting said tube over the item to which said shrink sleeve is to be applied and cutting the tube to the appropriate length; and
(E) shrinking said tube so that it conforms to the shape of the item.

46. Use of a polyurethane resin, in particular of a polyurethane resin according to claim 25, as a binder in a shrink sleeve printing ink comprising nitrocellulose.

47. Use of a binder material according to claim 36 for the manufacture of a shrink sleeve printing ink.

48. Use of a shrink sleeve printing ink according to claim 39 in the manufacture of shrink sleeves.
